(19) United States
(12) Patent Application Publication
(10) Pub. No.: US 2013/0192908 A1
(43) Pub. Date: Aug. 1, 2013

(54) Small Electrical Vehicle

(71) Applicant: Julian Schlagheck, Muenchen (DE)

(72) Inventor: Julian Schlagheck, Muenchen (DE)

(73) Assignee: Schlagheck Design GmbH, Oberhacing (DE)

(21) Appl. No.: 13/575,253

(22) PCT Filed: Jan. 25, 2011
(86) PCT No.: PCT/EP2011/000298

§ 371 Date: Nov. 16, 2012

(30) Foreign Application Priority Data
Jan. 26, 2010 (DE) 20201001374.7
Mar. 28, 2010 (EP) 10003321.6

(51) Int. Cl. B60L 11/18

(52) U.S. Cl. CPC B60L 11/18
USPC 180/65.1

(57) ABSTRACT

The invention relates to a small vehicle for personal transport having an electrical drive comprising at least an electrical motor (16), a battery (17), a main body (1) which extends longitudinally from a front and to a rear end, wherein one or two front wheels (2) and at least two rear wheels (3) are fastened on the main body (1), and a steering device (8, 9) for steering one or more of the wheels (2), wherein at least the rear half of the main body (1) is limited above by a substantially level loading surface (4) and the electrical motor (16) and the battery (17) are arranged underneath the loading surface (4) or in one or more of the wheels (2, 3), characterized in that there is a seating device (11) comprising a seating surface (12) which is borne by supports (13), wherein the supports (13) are attached on the outer lateral ends of the main body (1) or the loading surface (4).

This application claims the priority of International Application No. PCT/EP2011/000298, filed Jan. 25, 2011, and German Patent Document No. 20 2010 001 374.7, filed Jan. 26, 2010, and European Patent Document No. 10003321.6, filed Mar. 28, 2010, the disclosures of which are expressly incorporated by reference herein.

### BACKGROUND AND SUMMARY OF THE INVENTION

The invention relates to a small vehicle for transporting persons, having an electric drive which comprises at least one electric motor, having a battery, having a base body which extends longitudinally from a front and to a rear end, wherein one or two front wheels and at least two rear wheels are fastened to the base body, and having a steering device for steering one or more of the wheels, wherein at least the rear half of the base body is bounded in the upward direction by an essentially level loading surface, and wherein the electric motor and the battery are arranged underneath the loading surface or in one or more of the wheels.

Various types of small vehicles which are intended to simplify the mobility of elderly and disabled persons are known from the prior art. These mobility scooters or electric scooters are embodied as electrically driven small vehicles with a steering handlebar and a seat which is arranged centrally above the longitudinal axis of the vehicle.

Furthermore, small electric vehicles for specific purposes of use are known. These include, for example, electric golf buggies, which are in some cases also referred to as electric golf caddies. For leisure time activities, two-wheeled, self-balancing electric vehicles are also provided. All these small vehicles have in common the fact that they are tailored to a specific field of application.

The object of the present invention is to develop a small vehicle which can be used for a multiplicity of purposes of use and which can be used in a versatile way in everyday life.

This object is achieved by means of a small vehicle for transporting persons,

having an electric drive which comprises at least one electric motor,

having a battery,

having a base body which extends longitudinally from a front and to a rear end, wherein one or two front wheels and at least two rear wheels are fastened to the base body, and

having a steering device for steering one or more of the wheels, wherein at least the rear half of the base body is bounded in the upward direction by an essentially level loading surface, and wherein the electric motor and the battery are arranged underneath the loading surface or in one or more of the wheels, and, as a result, which is characterized in that a seating device is provided which comprises a seating surface which is mounted by supports, wherein the supports are mounted at the outer lateral ends of the base body or of the loading surface.

In one preferred embodiment, the base body is bounded in the region between the front wheel or wheels and the rear end of the base body in the upward direction by a substantially level loading surface, and the electric motor and the battery are arranged underneath the loading surface or in one or more of the wheels.

A small vehicle is understood within the scope of this description to be a land vehicle which reaches a speed of up to 60 km/h. In alternative embodiments, the small vehicle according to the invention has a maximum speed of 50 km/h, 40 km/h, 30 km/h, 25 km/h, 20 km/h or 15 km/h.

The small vehicle is preferably provided for use in a radius of activity of up to 10 km. A radius of activity is to be understood here as the distance within which the destinations which are to be reached with the small vehicle are located. The small vehicle should usually be able to travel this distance several times, for example 5 to 20 times or 8 to 15 times, without the battery being recharged. Depending on the design of the small vehicle, the preferred area of use may also be within a radius of activity of up to 5 km or up to 2 km. The small vehicle will advantageously be used in town center areas or in areas near to towns. If the destinations which are to be travelled to are not too far apart from one another, the small vehicle can also advantageously be used in rural areas, for example in villages or between adjacent villages.

The length of the small vehicle according to the invention is preferably less than 200 cm, preferably at maximum 160 cm, particularly preferably at maximum 140 cm. The maximum width of the small vehicle is preferably 120 cm, particularly preferably 100 cm, very particularly preferably 80 cm.

A preferred field of use of the small vehicle is the transportation of elderly people, people with walking difficulties or unwell people as well as a transportation vehicle for shopping and errands, in particular in town center areas.

The term “battery” is intended to be understood as referring to means for storing electrical energy. As well as batteries in the narrower sense, in particular rechargeable batteries or accumulators are to be understood as being covered by the term battery.

The term “base body” is understood to be a body which has a sufficient degree of rigidity and which performs the function of the chassis of the small vehicle and/or serves as a vehicle platform. The base body forms the basis of the vehicle to which significant vehicle parts such as, for example, the wheels or a steering device, are fastened or which supports significant parts of the vehicle, such as, for example, a seat, side walls or a roof. The base body may be embodied, for example, as a frame, rack or as a block-like body.

If the base body is made of metal, in one preferred embodiment it is manufactured by deep drawing or tensile compression shaping of one or more metal blanks.

The small vehicle according to the invention has a base body to which the wheels of the vehicle are fastened using suitable fastening means. In a four-wheeled vehicle, the wheels are preferably attached laterally to the base body. The base body can also have cutouts for the wheels. As a rule, the wheel suspension components, that is to say the means of fastening the wheels to the base body, are also provided with sprung or damping elements in order to decouple the base body from vibrations or impacts of the wheels.

The base body is largely closed off on its upper side, that is to say on the side facing away from the underlying surface, for example the road, in the driving mode by a substantially level loading surface. This loading surface extends at least over the rear half of the base body, that is to say in the longitudinal direction from the rear end of the vehicle as far as the center of the vehicle. The loading surface preferably extends from the rear end of the base body as far as the front wheels or, in the case of a three-wheeled vehicle, as far as the front wheel.

The expression “as far as the front wheels or as far as the front wheel” means up to a line extending transversely with respect to the longitudinal direction of the base body, which line is displaced by half the wheel diameter to the rear from the axle of the front wheels. The term “longitudinal direction” is understood to mean the direction in which the small vehicle is moved in the straight-ahead orientation.

The substantially level loading surface which closes off the base body in the upward direction can also extend over the dimensions of the base body. For example, the base body can be composed of a longitudinal member and a plurality of cross members on which a rectangular plate is attached as a loading surface. It is also possible to attach the wheels to the side of the base body and to provide a loading surface which covers the base body and the wheels.

The small vehicle is provided with an electric drive and at least one battery as a power supply, as an energy accumulator or as an energy source. The electric drive comprises, one or more electric motors for driving the vehicle. According to the invention, both the battery and the electric motor are arranged underneath the loading surface, that is to say underneath the substantially level upper boundary of the base body and/or in the wheels. Electrical lines and other components of the electric drive of the vehicle such as, for example, electrical power converters, switches, power actuating devices such as, for example, electronic power actuators etc., are also preferably provided underneath the level loading surface. Particularly preferably only the components which are necessary for the driver to control the small vehicle, such as an on/off switch and means for controlling the speed and/or direction are provided above the loading surface. Mechanical drive elements, such as a drive shaft, are preferably also provided underneath the loading surface.

According to the invention, a large part of the loading surface is not occupied by the battery or the electric drive and is therefore available for other purposes, in particular for transporting persons or objects. In one preferred variant, both the battery and the electric motor are arranged underneath the loading surface. In another embodiment of the invention, the loading surface is kept free by virtue of the fact that one or more wheel hub motors are provided, i.e. the electric motor or motors is/are arranged in the wheels in this case.

As a result of the inventive arrangement of the battery and electric motor underneath the level loading surface or in the wheels, a relatively large, substantially level surface is available which can be used for transporting a wide variety of objects. In addition, as a result of the low arrangement of the battery, the center of gravity of the vehicle is lowered, as a result of which the driving properties are improved. In the previous vehicles, in particular the battery was arranged above the base body, for example underneath the seat, as a result of which the effective useable area of the small vehicle was significantly reduced and the center of gravity of the vehicle was raised.

According to the invention, an underfloor concept is therefore proposed in which the loading surface is reduced neither by the electric motor nor by the battery. The electric motor and the battery are arranged underneath the substantially level loading surface or in the wheels.

In one preferred embodiment, the battery or batteries can be inserted from the side, from the front or from the rear into the base body and/or under the loading surface. For this purpose, for example a drawer is provided for holding the battery, into which drawer the battery is placed and then pushed into the base body and/or under the loading surface. As a result of the insertion of the battery into the base body and/or under the loading surface, the battery is advantageously automatically connected to the electrical system of the vehicle, in particular the electric motor. For example, the drawer is provided with a plug to which the battery which is located in the drawer is connected. After the complete insertion of the drawer into the base body or into the loading surface, the plug engages in a socket which is located in the base body and produces a current-conducting contact between the battery and the electrical system of the vehicle. The batteries can be inserted into the vehicle like a cartridge and can easily be removed from the vehicle for charging in an external charging station.

Instead of a drawer it is also possible to embody the battery itself in such a way that it can be pushed into a corresponding opening in the base body. For this purpose, the battery can be equipped with guide strips which interact with corresponding guide strips in the opening in the base body provided for the battery and which permit the battery to be inserted into the base body.

The small vehicle according to the invention primarily serves for transporting persons and is preferably configured for transporting a single person. In the case of vehicle seats according to the prior art, the seating surface is borne by a central support which is connected to the base body in the region of the longitudinal axis of the small vehicle. This has the disadvantage that bulky goods can no longer be accommodated under the seat. There is frequently no further space at all available on the vehicle in order to be able to transport relatively large items.

According to the invention, a seating device is provided which comprises a seating surface which is borne by supports or carriers, wherein the supports or carriers are attached to the outer lateral ends of the base body and/or to the outer lateral boundaries of the loading surface. The supports can be fastened laterally to the base body, with the result that the free useful area on the upper surface of the base body is not restricted by the supports. It is frequently more appropriate in technical terms to attach the supports to the upper side of the base body. In this case, the supports are fastened as far as possible on the outside, with the result that an area of the planar upper side of the base body or of the loading surface which is as large as possible remains free and usable between the two supports. The supports take up at most an edge region of the loading surface. A support is not provided on each side of the longitudinal axis of the vehicle, in a central strip.

In one particularly preferred variant, the free length between the supports extends in the transverse direction of the base body, over at least 80%, preferably at least 90%, of the transverse extent of the loading surface at this point. The supports, usually one support or two supports on each of the two sides, are attached far enough toward the outside to enable the space under the seating surface to be used, for example, for transporting crates, large bags or other bulky goods. It is favorable to provide the supports in such a way that their outer sides are flush with the outside of the small vehicle, of the loading surface and/or with the base body.

The seating surface is advantageously embodied as a seating bench which extends transversely with respect to the longitudinal axis of the vehicle. This has the advantage that, if appropriate, as well as the driver a further person, for example a child, or a small pet or relatively small pieces of baggage, can also be carried along. However, it is also possible to provide a seating surface which is designed for precisely one person, that is to say a single seat. This embodiment generally permits the user to be seated in a more comfortable and more stable fashion. Both when the embodiment as a seating bench is adopted as well as when a single seat is provided, it is expedient to equip the seat with a back rest, and, if appropriate, with arm rests or arm supports.

In one preferred variant, the seating bench has a projecting part in the center, in the direction of the longitudinal axis of the vehicle. The projecting part is configured in such a way that the driver can sit astride it, that is to say the driver is seated on the seating projection as he would be on a motor cycle or motor scooter. A further person can sit behind the driver on the seating bench extending transversely with respect to the longitudinal axis of the vehicle.

It is also possible to provide, in respect of the seating bench which extends transversely with respect to the longitudinal axis of the vehicle, a seating bench which extends in the longitudinal direction and which is fastened to the lateral supports by means of suitable struts or mounts. The seating bench may be so long that one or two persons can be seated on it. In particular, if the small vehicle according to the invention is made so narrow that two persons can only be seated with difficulty next to one another, it has proven advantageous in terms of ergonomics and comfort to position the two persons one behind the other.

It is also favorable to provide the seating device with a vertical adjustment means. The vertical adjustment means is advantageously integrated into the lateral supports here. Such vertical adjustment is advantageous in the case of a seating bench which is oriented transversely with respect to the longitudinal axis of the vehicle, in the case of a seating bench which is oriented longitudinally with respect to the longitudinal axis of the vehicle, in the case of the seating bench variant described above with a projecting part or else in the case of a single seat.

As mentioned above, the vehicle according to the invention is equipped with a seating device in order to facilitate transportation of persons or make it more comfortable. The transportation of very large goods can, however, also be made difficult or even impossible as a result of the presence of a permanently installed seating device. The seating device is therefore advantageously provided with quick-release devices so that it can be quickly and easily connected to the vehicle or disconnected therefrom. After the removal of the seating device, the small vehicle can be steered from a standing position, with the result that there is sufficient space for transporting the baggage or goods.

The small vehicle advantageously has four wheels. Basically, the inventive advantages of the free, relatively large level loading surface are also obtained with three-wheeled vehicles. However, the invention has a particularly positive effect in four-wheeled small vehicles since they do not tip over even when they are loaded relatively heavily, as is permitted by the invention.

The small vehicle is preferably steered by means of a steering device with a steering column which is connected to the base body or the loading surface in the front third thereof. The two rear thirds of the upper side of the base body or of the loading surface can therefore be used for transporting persons and/or material.

It is also favorable to provide the steering column with a folding mechanism, so that, for example, when the small vehicle is parked, the steering column can be folded down onto the base body or the loading surface. In addition, the steering column can be adapted by changing its inclination to drivers of various sizes or can even be folded upward to such an extent that driving in a standing position is made possible.

In a further preferred variant, the level loading surface extends over at least 60%, preferably at least 70%, particularly preferably at least 80% of the surface of the base body. At least 60%, preferably at least 70%, particularly preferably at least 80%, of the upper side of the base body is therefore formed by a substantially planar surface.

The base body can be embodied, for example, as a frame or rack or can comprise a plurality of carriers connected to one another. The substantially level loading surface is preferably formed in this case by one or more plates or pieces of sheet metal which are mounted on the frame or rack.

In another preferred embodiment, the base body is constructed from a small number of individual parts, for example at maximum five. The base body can, for example, be assembled from one or more cast parts or be composed of a suitable plastic material or composite material. Corresponding fastening points are used to accommodate the steering device, the battery, the electric motor, the wheels and/or further suspension elements or damping elements.

The substantially level loading surface can, according to the invention, be used for accommodating goods since in the underfloor concept according to the invention substantial parts of the drive and of the control of the small vehicle are arranged under the loading surface. The level loading surface is preferably provided on its upper side with attachment means, in particular eyelets, rails or nets, for attaching and/or securing goods to the loading surface. The attachment means can also be adapted to specific transportation containers such as crates or trunk chests in order to secure them quickly and easily to the loading surface.

In a further preferred embodiment, at least one transportation container is provided which is attached at a location outside the level loading surface on or to the small vehicle. In particular in the front region of the vehicle, the steering column is frequently fastened to the base body and therefore does not permit a continuous level loading surface. In order to increase the loading volume, it is favorable to provide a transportation container which is fastened to the vehicle at locations which are otherwise not available for loading.

The transportation container particularly preferably extends over the front part of the vehicle to end up behind the front wheels. The transportation container is preferably embodied as a basket or crate and is fastened to the vehicle with a quick-release closure. For purchases, the transportation container can therefore be easily removed from the vehicle and carried. The transportation container can also be provided with rollers so that after removal from the vehicle it can be pushed or pulled and does not have to be carried.

For safety reasons it is advantageous to provide lateral struts at the level of the entry to the seating device. This is preferably made possible by virtue of the fact that a substantially U-shaped bar is provided which is rotatably mounted. A U-shaped bar is understood to be a bar which has two substantially straight limbs and a cross-strut connecting the two limbs. The ends of its two limbs are preferably fastened to the supports of the seating device, preferably to its upper end. In order to get on the vehicle, the bar is folded upwards, with the result that the two limbs are directed obliquely or vertically upward. After the driver has sat down on the seat, the bar is folded downward, with the result that the two limbs of the U-shaped bar are positioned next to the seating device.

In a further embodiment, at least one further bar is provided, and a film-like material is fastened between the two bars. A film-like material is understood to be, in particular, a thin, flexible, planar material, for example a woven material, in particular a textile material, a PVC sheet or some other plastic sheet or a rubber material. The film-like material is advantageously weatherproof, weather-resistant, waterproof and/or at least partially transparent.

The film-like material extends over the width of the bars, that is to say over the length of the cross-strut which connects the two limbs of the U-shaped bar. The further bar can either be arranged in a specific position, preferably a substantially perpendicular position, in a fixed fashion, or can also be movable. By moving the two bars relative to one another it is possible to extend the film-like material between the two bars. The film-like material then forms a surface between the cross-struts of the two bars which, depending on the orientation of the bars, serves as a roof for the driver or as a windshield. The bars therefore form, together with the film-like material, a soft top or a movable cover.

The film-like material is also preferably extended between the limbs of two bars and then forms a lateral protection, for example against rain or splashes.

More than two, in particular three, bars are preferably provided for extending the film-like material.

In one preferred embodiment, the loading surface or a part of the loading surface is embodied as a solar module or a photovoltaic module. An area of the loading surface which is as large as possible, preferably more than 50%, particularly preferably more than 75% and very particularly preferably more than 90%, of the loading surface advantageously serves as a solar module.

The terms solar module and photovoltaic module are used synonymously and are intended to describe a system which comprises a plurality of solar cells by means of which light is converted into electrical energy. When the small vehicle is parked, the electrical energy which is generated is used for charging the battery. Electrical energy is also generated during the driving mode by direct or indirect solar radiation on the solar module, which energy is then used to drive the electric motor and/or to charge the battery.

The solar module is preferably embodied in such a way that it is non-crushable, can be walked on and/or is waterproof so that the part of the loading surface which is covered with the solar module can also be walked on by the driver and can be used for transporting goods. The solar module can be protected on its upper side by means of, for example, glass, transparent plastic, epoxy resin, casting resin or suitable films. It is possible to use, for example, film-backed modules, laminated glass-glass modules, glass-glass modules using casting resins, glass-glass modules using composite safety film technology (PVB films), thin-layer modules behind glass or as a flexible coating, for example on a copper strip or fluorescence collectors. The solar cells may also be applied to a thin carrier plate, usually made of metal, and covered with a weather-resistant, transparent film.

The invention and further details of the invention are explained in more detail below with reference to exemplary embodiments which are illustrated schematically in the drawings.

### BRIEF DESCRIPTION OF THE DRAWINGS

FIG. 1 shows a small vehicle according to the invention,

FIG. 2 shows an alternative embodiment of the small vehicle according to the invention,

FIG. 3 shows the components of the small vehicle according to FIG. 1 in detail,

FIGS. 4 and 5 show a further variant of the invention,

FIG. 6 shows a side view of the small vehicle with battery drawers, and

FIG. 7 shows a further embodiment of the seating bench of the vehicle.

### DETAILED DESCRIPTION OF THE DRAWINGS

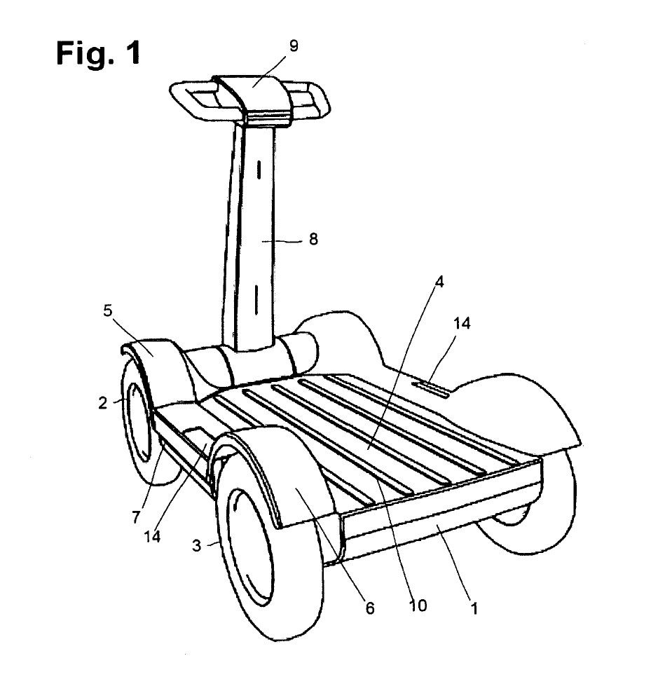

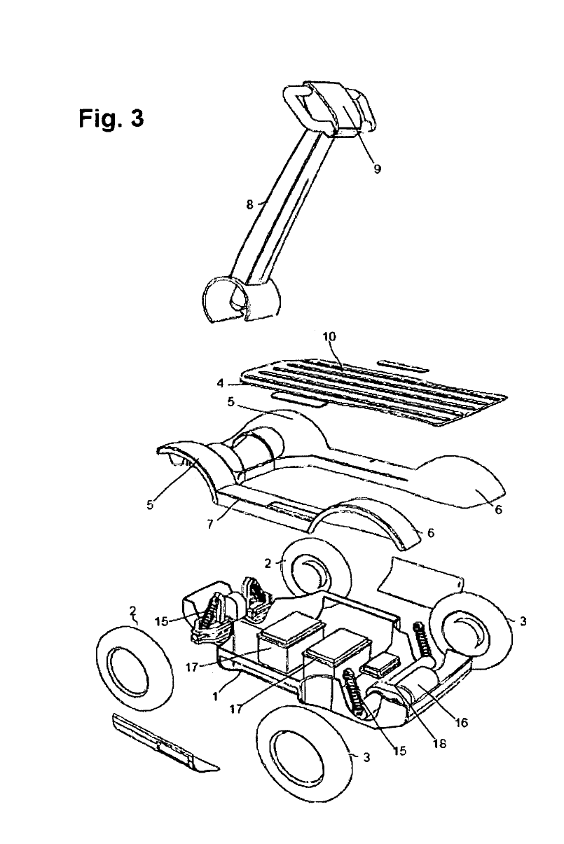

The small vehicle which is shown in FIGS. 1 and 3 has a block-shaped base body 1 which is manufactured, for example, by injection molding and serves as a chassis and a vehicle platform. The base body 1 is composed mainly of two injection-molded parts which are connected to one another and form the block-shaped base body 1. The base body 1 is formed by a body which is substantially rectangular in plan view and which extends in the longitudinal direction of the vehicle and has an extension 7, which is likewise rectangular in plan view, on its two longitudinal sides.

The base body 1 or parts of the base body 1 can also be fabricated by deep-drawing or tensile compressive shaping of one or more metal blanks or in some other way, for example by means of an injection pressing method or extrusion. The base body 1 can also be fabricated from plastic, from metal and plastic, from composite materials, fiber composites, or other materials.

In each case two front wheels 2 and two rear wheels 3 are attached to the two longitudinal sides of the base body 1. The base body 1 has for this purpose suitable fastening points (not illustrated in FIG. 1). In addition, as is apparent from FIG. 3, the wheels 2, 3 are spring-mounted with respect to the base body 1 using spring means and damping means 15.

The rear wheels 3 are driven by means of an electric motor 16. The electric motor 16 and two accumulators 17 which serve as a power supply and the cables which are necessary for supplying power to the electric motor and the drive train 18 for transmitting the force from the electric motor 16 to the drive wheels 3 are accommodated in the interior of the base body 1. In order to charge the accumulators 17, appropriate connections are provided on an outer side of the base body 1.

The upper side of the base body 1 is formed by a substantially level loading surface 4. Fenders 5, 6 are attached to the longitudinal sides of the base body 1 by means of the wheels 2, 3. The front fender 5 and the rear fender 6 each adjoin the lateral running boards 7, with the result that the base body 1, the fenders 5, 6 and running boards 7 form a substantially rectangular surface in plan view.

In the front region of the vehicle between the front wheels 2, a steering column 8, whose inclination is adjustable, is fastened to the base body 1. The steering column 8 can be moved to a substantially upright position (as illustrated in FIG. 1) or else moved into an oblique position in the rearward or forward directions by tilting, and can therefore be adapted to different sizes of driver. The steering column 8 can also be folded into a virtually horizontal position, for example after the vehicle has been parked.

At the upper end of the steering column 8, an operator control unit 9 is provided which can be used to steer the front wheels 2, actuate the electric motor 16 and therefore drive the small vehicle. The operator control unit 9 comprises an on and off switch for the electric motor 16, a speed regulator and, if appropriate, further switches and regulators in order, for example, to switch or regulate other electrical devices on the small vehicle, such as a lighting system.

The electric motor 16, the accumulators 17, all the elements for transmitting the force from the electric motor 16 to the wheels 3 and at least partially the wheel suspension devices 15 are arranged underneath the loading surface 4. In this way, a free loading surface 4 which is as large as possible is obtained.

The loading surface 4 of the base body 1 is provided with fastening rails 10 which extend in the longitudinal direction of the loading surface 4 and to which goods which are to be transported can be secured. Instead of the fastening rails 10, or in addition thereto, eyelets or hooks can also be provided for fastening transportation goods. It is also possible to attach a solar module, which also serves as a loading surface 4, to the base body 1. The solar module is of weather-resistant and crushproof design.

In the embodiment illustrated in FIG. 1, the vehicle can be controlled by a person standing on the vehicle or by a person running in front of or next to the vehicle.

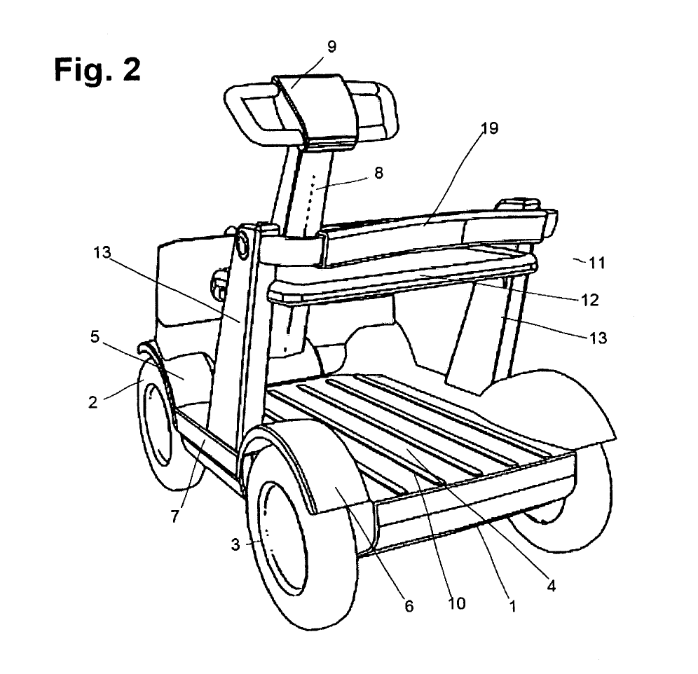

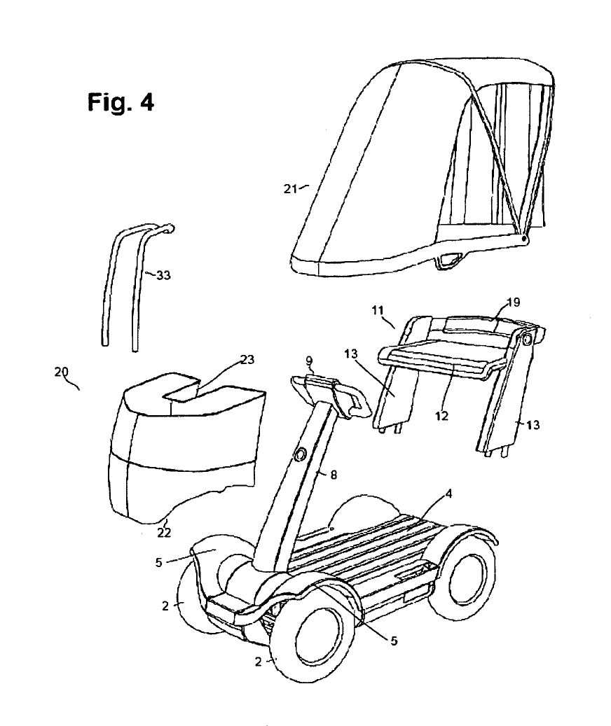

FIG. 2 shows a variant of the small vehicle according to FIG. 1 with a seating bench 11 (see also the exploded drawing in FIG. 4). The seating bench 11 has a seating surface 12 which extends over the entire width of the small vehicle, that is to say transversely with respect to its longitudinal direction. The seating bench 12 is provided at its two outer ends with supports 13 which engage in corresponding cutouts 14 (see FIG. 1) and can be fastened there with quick-release closures. In this way, the vehicle according to the invention which is shown in FIG. 1 can quickly be retrofitted for driving in a seated position.

The seating bench 11 is also provided with a back rest 19 which is pulled somewhat forward at the sides of the seating surface 12 and is fastened to the supports 13. The upper sides of the supports 13 can also serve as arm rests.

The supports 13 of the seating bench 11 are secured at the outer end of the lateral extensions 7 of the base body 1 in the cutouts 14. The supports 13 are flush at their outer side with the outer side of the loading surface 4. The loading surface 4 is freely usable for the transportation of objects between the two supports 13, over virtually the entire width of the vehicle.

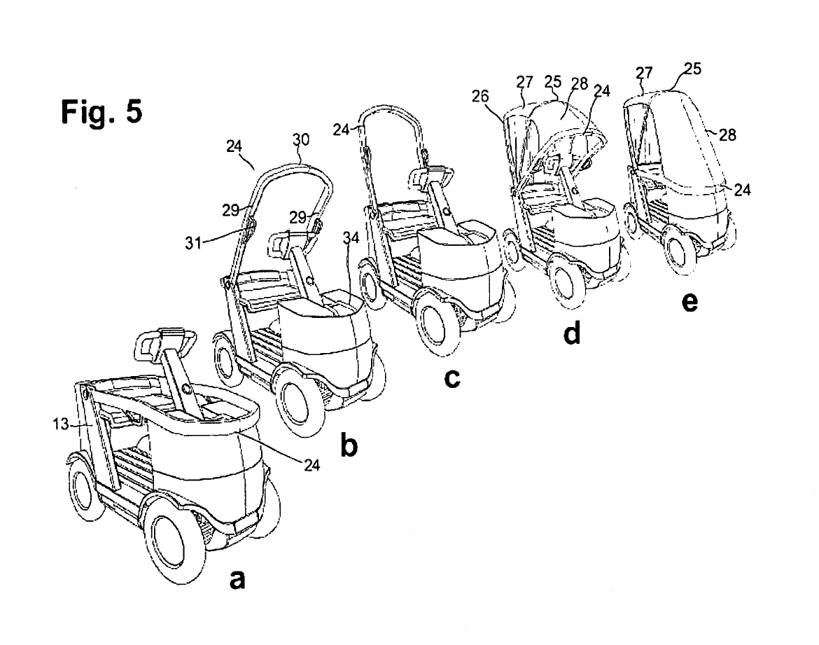

FIGS. 4 and 5 illustrate a further variant of the small vehicle according to the invention. The vehicle shown corresponds to the design according to FIG. 2, but additionally has a transportation basket 20 and roof 21.

The transportation basket 20 can be attached to the front part of the small vehicle. The transportation basket 20 is for this purpose fitted from the front and/or above onto the vehicle. The lower end 22 of the transportation basket 20 is embodied in such a way that the basket 20 is flush with the front fenders 5. The basket 20 extends in the longitudinal direction, preferably from the front end of the vehicle to behind the front wheel axle. The transportation basket 20 also has an indent 23 for the steering column 8, so that the inclination of the steering column 8 can be changed even when the basket 20 is attached.

The loading volume of the small vehicle is significantly increased by the transportation basket 20. The region between the front wheels 2 in which the steering column 8 is also fastened can therefore likewise be used for transportation purposes.

The transportation basket 20 is preferably provided with a quick-release locking means for fastening to the vehicle. The transportation basket 20 can therefore be quickly and easily mounted on the vehicle or removed when it is not required. The transportation basket 20 advantageously has a carrying handle and/or rollers in order to be able to easily carry or move the transportation basket 20 after removal from the vehicle. The transportation basket 20 may be used, for example, for purchases.

Furthermore, a metal bar 34 is advantageously provided and is fastened to the vehicle in front of the steering column 8 (see FIGS. 4 and 5). The metal bar 34, in particular a steel or aluminum bar, provides the following advantages and/or functions:
The metal bar 34 supports the locking and fastening of the transportation basket 20 to the vehicle.
The metal bar 34 is advantageously embodied as a pipe or piece of round steel so that motor cycle accessories such as, for example, additional lighting devices, bells, baggage securing devices and the like can easily be attached to the metal bar 34.
Furthermore, hooks or eyelets for fastening baggage, for example for suspending plastic bags or other bags, can be welded onto the metal bar 34 or attached in some other way.

FIGS. 4 and 5 also show a roof or soft top 21 which can be additionally attached to the vehicle. The roof 21 has a U-shaped bar 24 which is rotatably fastened to the supports 13 of the seat 11. The bar 24 can, as illustrated in FIG. 5, be moved into various positions. If the bar 24 is folded into a substantially horizontal position (FIG. 5a), the bar 24 serves as a means of securing the driver against unintentionally falling out. In order to get in and out of the vehicle, the bar can be moved upward, as shown in FIGS. 5b and 5c. The operation of the bar 24 is made easier by a handle 31 which is attached to the bar 24.

Two further U-shaped bars 25, 26 are rotatably attached to the supports 13. All the bars 24, 25, 26 are embodied substantially in a U shape with two limbs 29 and a cross-member 30 which connects the two limbs of the “U”. The bars 25, 26 can either be secured to the bar 24, or the bar 24 has a depression into which the bars 25, 26 can be inserted. In this way, the bars 25, 26 can be moved together with the bar 24, as is shown in FIGS. 5 d-e.

Two preferably weatherproof, watertight flexible material-like or film-like segments 27, 28 are fastened between the bars 24, 25, 26. The segments 27, 28 are composed, for example, of a textile or a plastic film. The segment 27 which is extended through the bars 25 and 26 forms a roof over the seat 11 for the driver as a protection against the rain and the sun. It is also favorable to attach to the rearmost bar 26 a further film or web of material or fabric which hangs down behind the driver when the soft top is extended and therefore additionally protects the driver against the influences of the weather. Both this rear termination of the soft top and optionally present side walls and/or the front segment 28 can also be fastened at their respective lower ends to the vehicle, for example by means of snap fasteners.

In the folded-down state, in which the bar 24 is rotated into the substantially horizontal position, the segment 28 between the bar 24 and the bar 25 serves as a windscreen of the vehicle. In this case, the segment 28 is composed at least partially of a transparent material.

Instead of two additional bars 25, 26, further bars can, of course, also be provided. Likewise it is possible to pull the segments 27, 28 from the fastening point of the bars 24, 25, 26 on the one support 13 to the fastening point of the bars 24, 25, 26 on the other support 13. As a result, side walls are also extended by the limbs 29 of the bars 24, 25, 26.

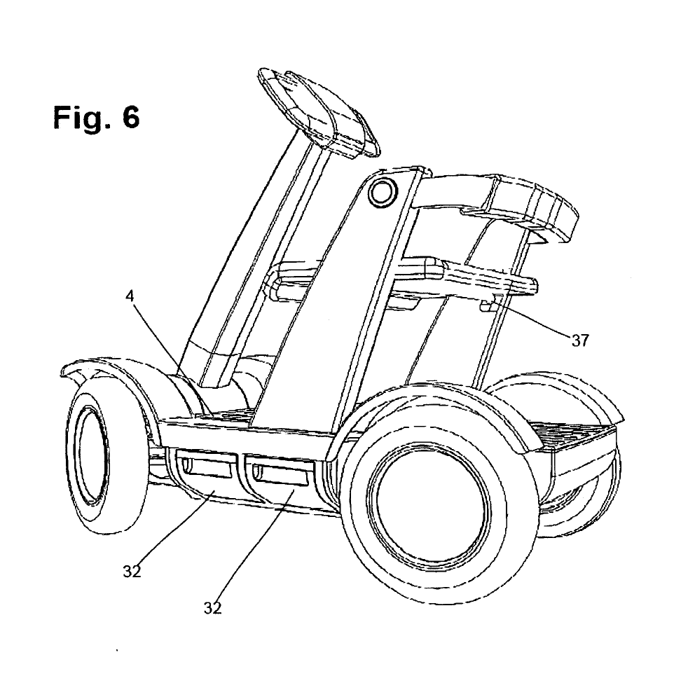

FIG. 6 illustrates a further advantageous detail of the small vehicle according to the invention. Two inserts 32 are provided on the longitudinal side of the vehicle. The inserts 32 serve to accommodate the batteries and/or accumulators. The batteries are placed in the inserts 32 and connected to electrical terminals located in the inserts 32. The electrical terminals are connected in a current-conducting fashion to further electrical contacts provided on the inserts 32. After the insertion of the inserts 32 into the corresponding openings underneath the loading surface 4, the electrical contacts of the inserts 32 are connected in a current-conducting fashion to opposing contacts, as a result of which the battery is automatically connected to the electrical system of the vehicle, in particular to the electric motor.

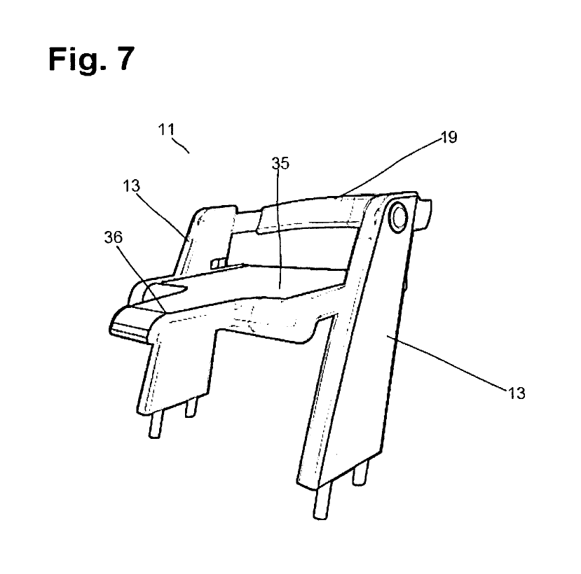

Finally, FIG. 7 shows an alternative design of the seating bench. The seating bench is fastened, like the seating bench illustrated in FIGS. 2 and 4, to lateral supports 13. The upper sides of the supports 13 can also serve as arm rests. In addition, a back rest 19 is also provided.

However, the seating surface 35 additionally has an extension 36 in the center, with the result that the seating surface 35, 36 is given a T-shaped appearance in plan view. The driver can sit astride the front projecting part 36. A passenger can sit behind the driver on the seating surface 35.

The entire seating surface 35, 36 is, like the seating surface 12 shown in FIGS. 2 and 4, of adjustable height. For this reason, corresponding locking or latching possibilities for fastening the seating bench at different heights are provided in the lateral supports 13. Such a vertical adjustment means with the reference symbol 37 can be seen in FIG. 6.

1.-14. (canceled)

15. A small vehicle for transporting persons, comprising:
an electric motor;
a battery coupled to the electric motor;
a base body which extends longitudinally from a front end of the small vehicle to a rear end of the small vehicle;
a front wheel and two rear wheels fastened to the base body;
a steering device coupled to the front wheel;
a substantially level loading surface, wherein a rear half of the base body is bounded in an upward direction by the loading surface, wherein the electric motor and the battery are disposed underneath the loading surface or in one or more of the front and rear wheels;
a seating device including a seating surface and supports, wherein the seating surface is mounted on the supports and wherein the supports are mounted at outer lateral ends of the base body or of the loading surface; and
quick-release devices, wherein the seating device is secured to the small vehicle by the quick-release devices.

16. The small electric vehicle as claimed in claim 15, wherein the base body is bounded in a region between the front wheel and a rear end of the base body in the upward direction by the loading surface.

17. The small vehicle as claimed in claim 15, wherein the steering device includes a steering column which is connected to the base body in a front third of the base body.

18. The small vehicle as claimed in claim 17, wherein an inclination of the steering column with respect to the loading surface is variable.

19. The small vehicle as claimed in claim 15, wherein the loading surface includes a fastening device.

20. The small vehicle as claimed in claim 15, further comprising a transportation container attachable on or to the small vehicle at a location outside of the loading surface.

21. The small vehicle as claimed in claim 15, wherein the loading surface extends over at least 80% of the base body.

22. The small vehicle as claimed in claim 15, further comprising a substantially U-shaped bar that is rotatably mounted to the supports.

23. The small vehicle as claimed in claim 22, further comprising a second substantially U-shaped bar and a film-like material, wherein the film-like material is fastened between the U-shaped bar and the second U-shaped bar.

24. The small vehicle as claimed in claim 15, wherein the battery is insertable under the loading surface.

25. The small vehicle as claimed in claim 15, wherein the seating surface is a seating bench which is oriented transversely with respect to a longitudinal axis of the small vehicle and which has a projecting part that extends in the longitudinal axis of the small vehicle.

26. The small vehicle as claimed in claim 15, wherein the seating device is vertically adjustable.

27. The small vehicle as claimed in claim 15, wherein at least a part of the loading surface is a solar module.
